(19) United States
(12) Patent Application Publication
(10) Pub. No.: US 2015/0193842 A1
(43) Pub. Date: Jul. 9, 2015

(54) Gas Supply Stop Instruction System and Gas Supply Stop Instruction Method

(71) Applicant: Nippon Gas Co., Ltd., Tokyo (JP)

(72) Inventors: Shinji Wada, Tokyo (JP); Shingo Dekamo, Tokyo (JP)

(21) Appl. No.: 14/412,923

(22) PCT Filed: Jul. 4, 2013
(86) PCT No.: PCT/JP2013/004163

§ 371 Date: Jan. 5, 2015

(30) Foreign Application Priority Data
Jul. 6, 2012 (JP) 2012-152636

(51) Int. Cl. G06Q 30/04; G06Q 40/00; G06Q 50/06; H04L 29/06

(52) U.S. Cl. CPC G06Q 30/04; H04L 67/42; G06Q 40/12; G06Q 50/06

(57) ABSTRACT

A delivery server includes a storage device configured to manage meter indication data for each gas meter, a reception unit configured to receive the meter indication data of the gas meter from a communication terminal, a calculation unit configured to calculate a gas bill for the current month based on the meter indication data, a determination unit configured to check an uncollected bill on the calculated gas bill for the current month and gas bills for previous months to determine whether or not a predetermined due date for payment has passed, and a processing unit configured to give a notification of gas cutoff or an instruction to disconnect gas supply, for each gas meter, based on a result of the determination.

### TECHNICAL FIELD

The present invention relates to a system and a method for managing the payment status of gas bills.

### BACKGROUND ART

LP gas is known to be supplied through imports from gas producing countries and domestic production based on by-products obtained during production of petroleum products. A primary station refers to an import station in which LP gas carried by tankers from a gas producing country is stored, and also refers to a petroleum purification station. LP gas is loaded from the primary station into non-international coastal trading vessels or tank trucks and then shipped to secondary stations that are coastal or inland transit stations for LP gas transportation. Moreover, the LP gas carried to the secondary stations is transported to local LP gas filling stations, that is, delivery bases, where the LP gas is filled into gas cylinders.

The gas cylinders filled with LP gas at the filling stations are delivered by deliverymen to customers' residences such as general households, housing complexes, and business establishments. Empty gas cylinders at the customers' residences are replaced with the filled gas cylinders and returned to the filling stations. For each of the filling stations, a fixed delivery area for which deliverymen are responsible is set. The deliverymen are provided with delivery slips for two to ten days related to delivery to the customers in the delivery area.

The delivery slips are created by a delivery manager. First, for each customer, the delivery manager predicts the remaining amount of LP gas in the gas cylinder based on gas usage history, the indication of a gas meter (hereinafter referred to as the “meter indication”), the history of delivery, and the like, to determine the next due date for gas cylinder delivery. The delivery manager performs estimation for all the customers in the delivery area for which the deliverymen are responsible to determine the amount of delivery of gas cylinders for two to ten days.

After replacing the gas cylinder in accordance with the delivery slip, the deliveryman fills in the date of the replacement, the meter indication of the day, the cylinder number, and safety inspection on the delivery slip. When the daily delivery operation ends, the delivery slips are submitted to the delivery manager. The delivery slips returned to the delivery manager are checked for completeness and stored as data used to calculate the next delivery due date. A system has been proposed which allows gas cylinders to be efficiently delivered based on the above-described process (see Patent Document 1).

Systems are conventionally present which allow gas cylinders to be efficiently delivered as disclosed in PTL 1. However, no system has been present which quickly gives a notification of gas cutoff or an instruction to disconnect gas supply at the time of meter reading depending on the outstanding status of a gas bill.

### CITATION LIST

### Patent Literature

PTL 1: Japanese Patent Laid-Open No. H08-329159 (1996)

### SUMMARY OF INVENTION

### Technical Problem

With the foregoing in view, it is an object of the present invention to provide an instruction system for disconnecting gas supply and an instruction method for disconnecting gas supply which allows a notification of gas cutoff to be quickly made or allows an instruction to disconnect gas supply to be quickly given at the time of meter reading depending on the outstanding status of a gas bill.

### Solution to Problem

To accomplish the object, the present invention provides an instruction system for disconnecting gas supply, the system including a management unit configured to manage meter indication data for each gas meter, a reception unit configured to receive the meter indication data of the gas meter from a communication terminal, a calculation unit configured to calculate a gas bill for the current month based on the meter indication data, a determination unit configured to check an uncollected bill on the calculated gas bill for the current month and gas bills for previous months to determine whether or not a predetermined due date for payment has passed, and a processing unit configured to give a notification of gas cutoff or an instruction to disconnect gas supply, for each gas meter, based on a result of the determination.

Furthermore, to accomplish the object, the present invention provides an instruction method for disconnecting gas supply in which a computer gives a notification of gas cutoff or an instruction to disconnect gas supply, the computer including a management unit configured to manage meter indication data for each gas meter, the method including a step of receiving the meter indication data of the gas meter from a communication terminal, a step of calculating a gas bill for the current month based on the meter indication data, a step of checking an uncollected bill on the calculated gas bill for the current month and gas bills for previous months and determining whether or not a predetermined due date for payment has passed, and a step of giving a notification of gas cutoff or an instruction to disconnect gas supply, for each gas meter, based on a result of the determination.

### Advantageous Effects of Invention

The present invention allows a notification of gas cutoff to be quickly made or allows an instruction to disconnect gas supply to be quickly given, at the time of meter reading depending on the outstanding status of a gas bill.

### BRIEF DESCRIPTION OF DRAWINGS

FIG. 1 is a diagram depicting a configuration example of a network according to an embodiment of the present invention;

FIG. 2 is a block diagram depicting a configuration example of a delivery server in FIG. 1;

FIG. 3 is a flowchart depicting an example of general operation of the delivery server according to the embodiment of the present invention;

FIG. 4 is a diagram depicting an example of an operation screen, for meter reading, of a mobile terminal in FIG. 1;

FIG. 5 is a diagram depicting a configuration example of data indicative of a payment status of a gas bill which is checked for determination;

FIG. 6 is a diagram of an example of an operation screen displayed when the mobile terminal in FIG. 1 receives an instruction to execute a cock closing process because a customer is behind in payment;

FIG. 7 is a diagram depicting an example of meter indication data; and

FIG. 8 is a diagram depicting a configuration example of a plurality of meter indication data stored in a storage device of the delivery server in FIG. 1.

### DESCRIPTION OF EMBODIMENTS

A general configuration of a system according to the present embodiment will be described below. The system systematically determines an outstanding status of a gas bill and gives a notification of gas cutoff or an instruction to disconnect gas supply at the time of meter reading based on the result of the determination.

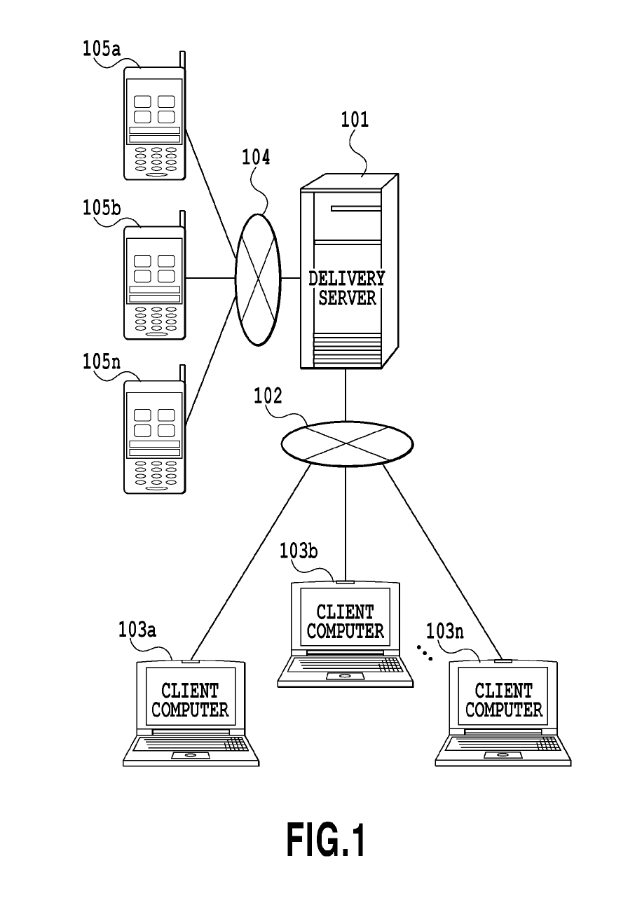

FIG. 1 is a diagram depicting a network configuration according to an embodiment of the present invention. In FIG. 1, a delivery server (instruction system for disconnecting gas supply) 101 is configured to be able to communicate with a plurality of client computers 103a, 103b, . . . , 103n via a network 102. Moreover, the delivery server 101 is configured to be able to communicate with a plurality of mobile terminals (communication terminals) 105a, 105b, . . . , 105n via a network 104. In descriptions common to the plurality of client computers 103a to 103n, each client computer is simply referenced as the client computer 103. In descriptions common to the plurality of mobile terminals 105a to 105n, each mobile terminal is simply referenced as the mobile terminal 105.

The client computers 103 are, for example, terminals installed at a delivery center that manages deliveries from the respective delivery bases in a unified manner and used by a user in the delivery center. The user connects to the delivery server 101 via the client computer 103 to use the delivery server 101 exclusively for delivery operations such as check of a delivery status and issuance of an instruction to create delivery data. The client computers 103 may be installed, for example, at a delivery base.

The mobile terminal 105 is a terminal used by an operator (including, for example, a meter reader, a deliveryman, and a safety inspector) who checks the meter indication of a gas meter attached to a supply facility with a gas cylinder. The mobile terminal 105 includes a CPU, a memory, an input device, and a display device. The operator collects and transmits meter indication data including the meter indication of the gas meter, to the delivery server 101. The meter indication data is transmitted to the delivery server 101, for example, at the time of meter reading, opening or closing of the gas cock, safety inspection, delivery of a gas cylinder, or replacement of the gas meter.

### [Configuration of the Delivery Server]

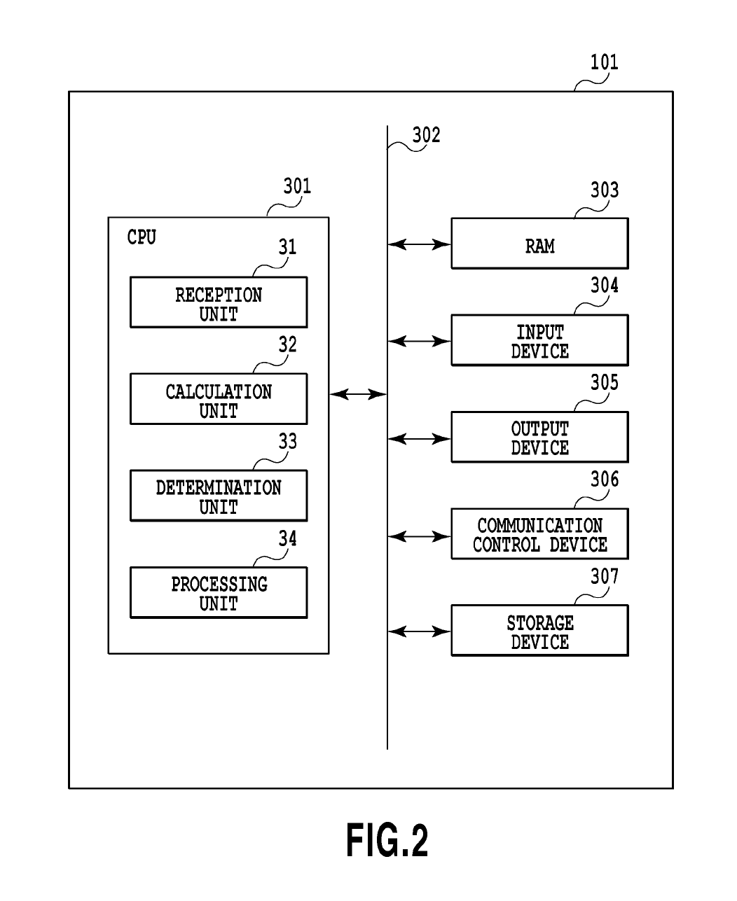

FIG. 2 is a block diagram depicting a configuration example of the delivery server 101. With reference to FIG. 2, adoption of a single computer is described. However, the delivery server 101 may be configured as a part of a multifunction distribution system including a plurality of computer systems.

As depicted in FIG. 2, the delivery server 101 has a CPU 301, a system bus 302, RAM 303, an input device 304, an output device, a communication control device 306, and a storage device (management unit) 307.

The CPU 301 is connected to components via a system bus 302 to carry out a process of transferring control signals and data and executes various software programs, arithmetic processing, and the like which are needed to implement the general operation of the delivery server 101.

RAM 303 includes a work area that temporarily store data and software programs.

The storage device 307 includes a nonvolatile storage medium such as ROM or HDD, a program storage area in which software programs are stored, and a data storage area in which data optionally obtained, data that is results of processing, and the like are stored. For example, the CPU 301 according to the embodiment implements the functions of respective units 31 to 34 described below by reading a software program from the program storage area of the storage device 307 into the work area of RAM 303 and executing the software program.

As depicted in FIG. 2, the CPU 301 includes a reception unit 31, a calculation unit 32, a determination unit 33, and a processing unit 34.

The reception unit 31 receives the meter indication data of the gas meter from the mobile terminal 105. The meter indication data is data on the gas usage, detected by the gas meter, of the gas cylinder provided in the supply facility. The meter indication data includes the meter indication indicative of the gas usage of the gas cylinder and a meter indication date. The meter indication data will be described below in detail.

The calculation unit 32 calculates the gas bill for the month of the meter reading (hereinafter referred to as the current month) based on the received meter indication data.

The determination unit 33 checks an uncollected gas bill which is calculated for the current month and uncollected gas bills for previous months to determine whether or not a predetermined due date for payment has passed.

The processing unit 34 gives a notification of gas cutoff or an instruction to disconnect gas supply, based on the result of the determination.

### [Operation of the Delivery Server]

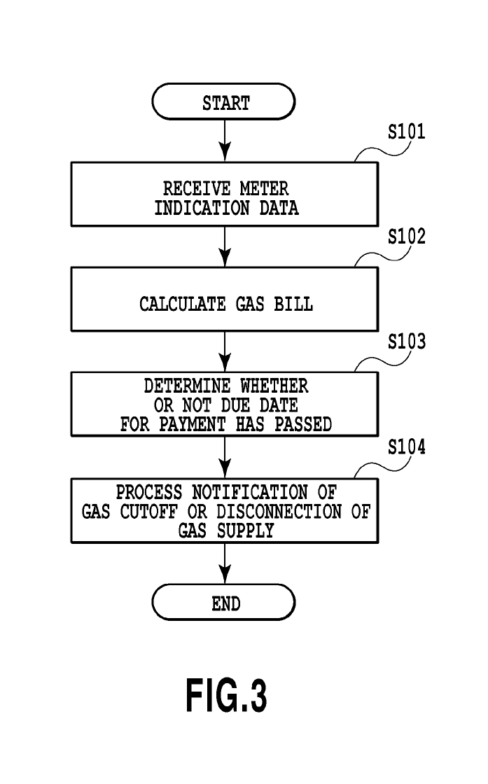

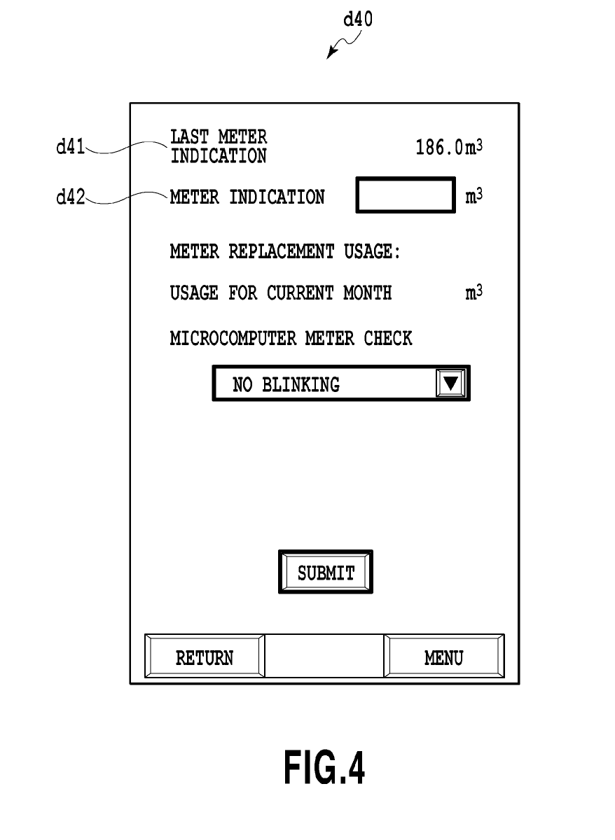

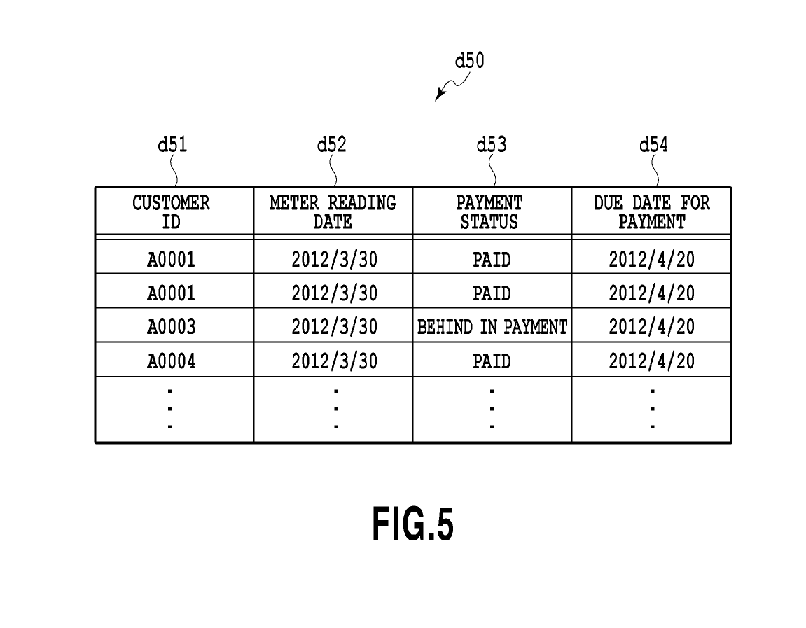

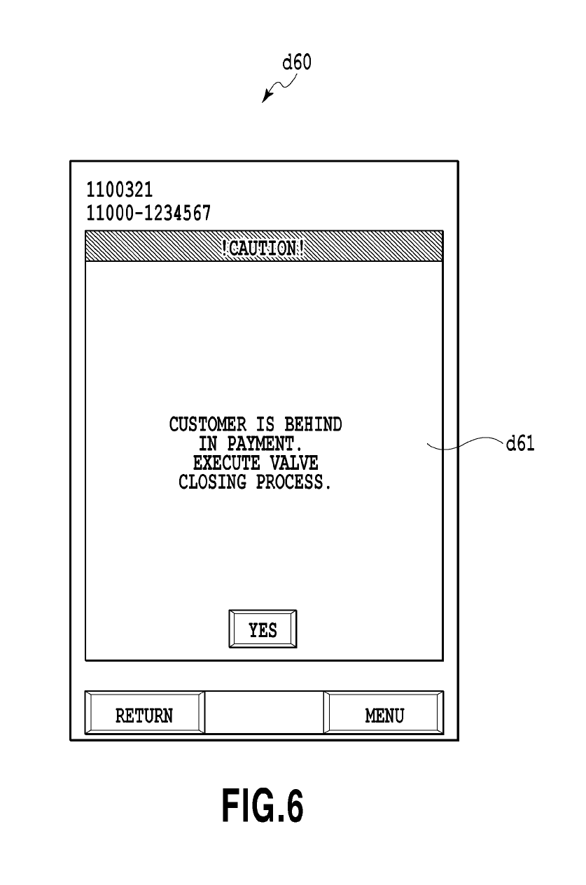

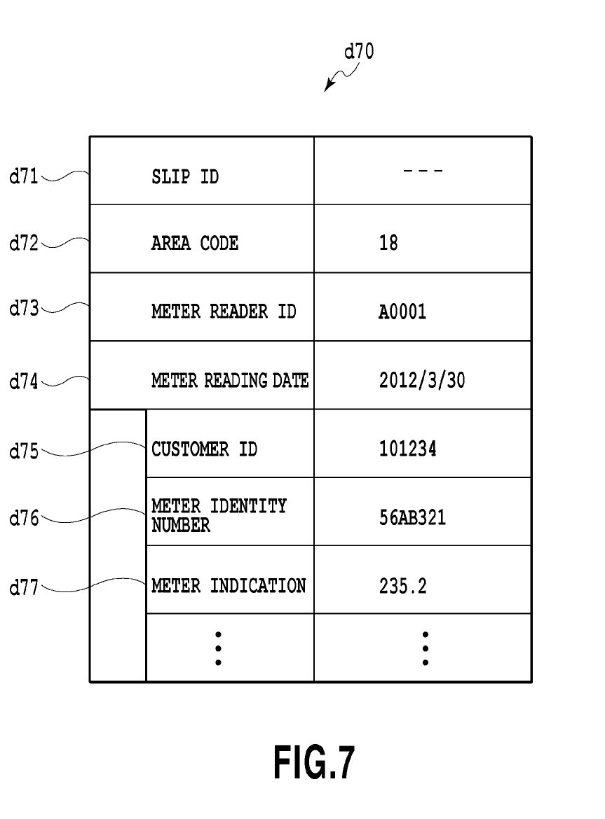

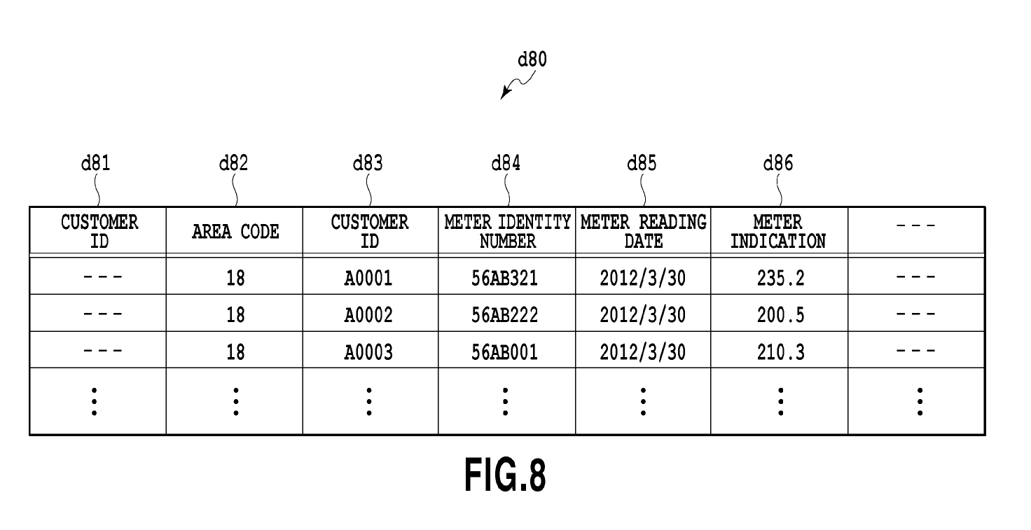

With reference to FIG. 3, FIG. 4, FIG. 5, FIG. 6, FIG. 7, and FIG. 8, a method will be described in which a gas meter reading process is executed using the meter indication data of the gas meter when the mobile terminal 105 transmits the meter indication data to the delivery server 101. FIG. 3 is a flowchart depicting an example of general operation of the delivery server 101. FIG. 4 is a diagram depicting an example of a display screen of the mobile terminal 105. FIG. 5 is a diagram depicting a configuration example of data indicative of the payment status of gas bills. FIG. 6 is a diagram depicting an example of an operation screen displayed when receiving an instruction to execute a cock closing process because the customer is behind in payment. FIG. 7 is a diagram depicting an example of meter indication data. FIG. 8 is a diagram depicting a configuration example of a plurality of meter indication data stored in the storage device 307 of the delivery server 101.

In FIG. 3, first, when the mobile terminal 105 transmits the meter indication data of the gas meter to the delivery server 101, the CPU 301 (reception unit 31) of the delivery server 101 receives the meter indication data (S101). FIG. 4 depicts an example of the operation screen of the mobile terminal 105 for meter reading.

As depicted in FIG. 4, an operation screen d40 includes, for example, a last meter indication d41 (which means the “last meter indication of the gas meter”) and a meter indication d42 (which means the “current meter indication of the gas meter”). In the description of the embodiment, data including the last meter indication and the meter indication are hereinafter referred to as the meter indication data of the gas meter. Thus, the meter indication data is transmitted to the delivery server 101. The above-described meter indication is obtained, for example, based on the operator's input operation.

The meter reader uses the mobile terminal 105 at the site to transmit the meter indication data for the current month to the delivery server 101. The CPU 301 (reception unit 31) of the delivery server 101 receives the meter indication data (S101).

The CPU 301 (calculation unit 32) of the delivery server 101 calculates the gas bill for the current month based on the meter indication data for the current month (S102).

In the meter reading process by the calculation unit 32, for example, the gas usage from the last meter reading date until the current meter reading date is determined from {(the meter indication on the current meter reading date)−(the meter indication on the last data of meter reading)}. Upon determining the gas usage, the calculation unit 32 calculates the “gas bill for the current month for the customer” in accordance with a predetermined formula (for example, (a base charge)+(a unit charge)×(the gas usage)). In other words, the gas bill for the current month of meter reading for the customer is a gas bill for the gas usage from the last meter reading date until the current meter reading date. The above-described method for calculating the gas bill is not limited to the above-described example, and the gas bill can be calculated in various aspects.

The CPU 301 (determination unit 33) of the delivery server 101 checks uncollected gas bills for previous months taking the gas bill for the current month into account to determine whether or not a predetermined due date has passed (S103). The determination is made using a table such as depicted in FIG. 5. A table d50 depicted in FIG. 5 contains a “customer ID” d51, the “meter reading date” d52, a “payment status” d53, and a “due date for payment” d54. The table d50 is stored in the storage device 307. The payment status indicates, for example, that the gas bill has been paid and that the customer is behind in payment. The due date for payment indicates the due date for payment for the gas bill. When the due date has passed, the customer falls behind in payment. The payment status indicating that the gas bill has been paid is set by the delivery server 101 by receiving information (customer data such as a customer ID, data indicating that the gas bill has been paid, the date of payment, and the like) from a transaction server (not depicted in the drawings). This allows execution of a process of checking whether or not the gas bills have been paid.

The CPU 301 (processing unit 34) of the delivery server 101 creates a notification of gas cutoff or an instruction to disconnect gas supply for each gas meter based on the result of the determination and transmits the notification or the instruction from the delivery server 101 to the mobile terminal 105 (S104). For example, when the result of the determination indicates that the gas bill for one month is unpaid, the notification of gas cutoff is created. When the result of the determination indicates that the gas bill is overdue by equal to or more than one month, the instruction to disconnect gas supply is created.

The mobile terminal 105 receives the notification of gas cutoff or the instruction to disconnect gas supply. FIG. 6 depicts an example of reception of the instruction to disconnect gas supply. FIG. 6 is a diagram depicting an example of a display screen for the instruction to disconnect gas supply on the mobile terminal 105. The display screen d60 in FIG. 6 displays a message “execute a cock closing process” d61. The meter reader checks the message and disconnects gas supply. Thus, the outstanding status of the gas bill can be systematically determined, and a notification of gas cutout can be quickly made or the instruction to disconnect gas supply can be quickly given at the time of meter reading based on the result of the determination.

Furthermore, by viewing the operation screen of the mobile terminal 105 in FIG. 6, the meter reader can determine in real time whether or not the customer for whom the meter reader is to read the gas meter is a target for a disconnection of the gas supply, by using a communication terminal at the site.

Now, meter indication data d70 for the meter indication date includes, for example, a slip ID d71 for meter reading, an area code d72, a meter reader ID d73, the meter reading date d74, a customer ID d75, a meter identity number d76 (which means the “meter identity number of the gas meter”), and a meter indication d77 (which means the meter indication of the gas meter”) as depicted in FIG. 7. According to the embodiment, the gas meter is provided with, for example, a QR code (Quick Response code/QR code) (registered trade mark) (readable information code). Thus, the mobile terminal 105 can obtain meter indication data except for the meter indication and the meter reading date by reading the QR code (registered trade mark). The meter indication depicted in FIG. 7 is obtained, for example, based on the meter reader's input operation. The meter reading date is, for example, the day when the QR code (registered trade mark) is read.

In the embodiment, upon receiving, from the mobile terminal 105, the meter indication data obtained on the meter reading date, the CPU 301 (reception unit 31) stores the meter indication data in the storage device 307. FIG. 8 shows an example of the storage.

As depicted in FIG. 8, the storage device 307 stores a plurality of meter indication data received by the CPU 301. A table d80 includes a customer ID d81, an area code d82, a customer ID d83, a meter identity number d84, the meter reading date d85, and a meter indication d86.

As described above, for each gas meter, the delivery server 101 according to the present embodiment manages the meter indication data and receives the meter indication data of the gas meter from the mobile terminal 105. The delivery server 101 calculates the gas bill for the current month based on the received meter indication data, checks an uncollected gas bill which is calculated for the current month and uncollected gas bills for previous months to determine whether or not the predetermined due date for payment has passed. Furthermore, for each gas meter, the delivery server 101 gives a notification of gas cutoff or an instruction to disconnect gas supply based on the result of the determination. Thus, the delivery server 101 can systematically determine the outstanding status of the gas bill and give a notification of gas cutoff or an instruction to disconnect gas supply at the time of meter reading based on the result of the determination.

The embodiment has been described above. However, the specific data structure and the like are not limited to the embodiment but may be changed.

1. An instruction system for disconnecting gas supply, the system comprising:
a management unit configured to manage meter indication data for each gas meter;
a reception unit configured to receive the meter indication data of the gas meter from a communication terminal;
a calculation unit configured to calculate a gas bill for the current month based on the meter indication data;
a determination unit configured to check an uncollected bill on the calculated gas bill for the current month and gas bills for previous months to determine whether or not a predetermined due date for payment has passed; and
a processing unit configured to give a notification of gas cutoff or an instruction to disconnect gas supply, for each gas meter, based on a result of the determination.

2. An instruction method for disconnecting gas supply in which a computer gives a notification of gas cutoff or an instruction to disconnect gas supply,
the computer comprising a management unit configured to manage meter indication data for each gas meter, the method comprising:
a step of receiving the meter indication data of the gas meter from a communication terminal;
a step of calculating a gas bill for the current month based on the meter indication data;
a step of checking an uncollected bill on the calculated gas bill for the current month and gas bills for previous months and determining whether or not a predetermined due date for payment has passed; and
a step of giving a notification of gas cutoff or an instruction to disconnect gas supply, for each gas meter, based on a result of the determination.

3. A computer readable storage medium comprising a computer executable instruction allowing a computer to execute the instruction method for disconnecting gas supply according to claim 2,
the computer comprising a management unit configured to manage meter indication data for each gas meter, the method comprising:
a step of receiving the meter indication data of the gas meter from a communication terminal;
a step of calculating a gas bill for the current month based on the meter indication data;
a step of checking an uncollected bill on the calculated gas bill for the current month and gas bills for previous months and determining whether or not a predetermined due date for payment has passed; and
a step of giving a notification of gas cutoff or an instruction to disconnect gas supply, for each gas meter, based on a result of the determination.
